(19) United States
(12) Patent Application Publication
(10) Pub. No.: US 2005/0105463 A1
(43) Pub. Date: May 19, 2005

(54) Method for classifying the traffic dynamism of a network communication using a network that contains pulsed neurons, neuronal network and system for carrying out said method

(76) Inventors: Gustavo Deco, Vilassar de Mar (ES); Bernd Schurmann, Haimhausen (DE); Jan Storck, Germering (DE)

Correspondence Address: STAAS & HALSEY LLP, SUITE 700, 1201 NEW YORK AVENUE, N.W., WASHINGTON, DC, 20005, US

(21) Appl. No.: 10/503,626

(22) PCT Filed: Jan. 31, 2003
(86) PCT No.: PCT/DE03/00277

(30) Foreign Application Priority Data
Feb. 5, 2002 (DE) 10204623.9

(51) Int. Cl. H04L 1/00

(52) U.S. Cl. 370/229

(57) ABSTRACT

A method classifies the traffic dynamism of a network communication using a network that contains pulsed neurons. Traffic data of the network communication are used as the input variables of the neuronal network. Temporal clusters obtained by processing the pulses are used as the output variables of the neuronal network. The traffic dynamism is classified by a synaptic model whose dynamism depends directly on the exact clocking of pre- or post-synaptic pulses.

### CROSS REFERENCE TO RELATED APPLICATIONS

This application is based on and hereby claims priority to PCT Application No. PCT/DE03/00277 filed on Jan. 31, 2003 and German Application No. 102 04 623.9 filed on Feb. 5, 2002, the contents of which are hereby incorporated by reference.

### BACKGROUND OF THE INVENTION

One aspect of the invention relates to a method for classifying the traffic dynamism of a network communication using a network that contains pulsed neurons, with the traffic data of the network communication forming the input variables of the neural network and whereby temporal clusters obtained by pulse processing form the output variables of the neural network, whereby the classification of the traffic dynamism takes place using a synaptic model, the dynamism of which depends directly on the exact clocking of the pre- and post-synaptic pulses.

Another aspect of the invention generally relates to the area of network communication and particularly of computer network communication. A packet-switching network is, in particular, considered as the communication network. Packet-switching networks are, for example, based on the use of the Internet protocol IP or Internet protocol ATM for cell-based networks. Models and assumptions regarding the traffic characteristics of both a new connection and also already established connections and those still to be expected, are required to determine whether and under what conditions, i.e. at what price and at what assured transmission quality, the use of a connection in packet-switching networks is permitted. Call Admission Control (CAC) and Quality of Service (QoS) are referred to in this connection. The aim is the associated specific variables such as profit, customer satisfaction, freedom from loss and similar optimized usage of the available communication bandwidth.

A substantial increase in the share of multimedia data on the Internet can be expected in the future. This is equivalent to a drastic increase in burst-type data that is associated with a variable bit rate and involves the risk of potentially high overload. Heavy demands on freedom from jitter are made in order to be able to receive isochronous data when communicating images and sound. A possible solution could be in the prioritization of the packets and in very careful CAC algorithms in order to be able to finally guarantee transmission quality up to the inclusion of liability. Inclusion of liability is, for example, important for critical transmission such as for surgical procedures using a video-conference link up.

The use of CAC algorithms with an adaptive characteristic is becoming unavoidable. Adaptive CAC algorithms are ground-breaking technical applications, because up to now the complete communication took place via permanently connected routing assuming “unlimited” bandwidth in accordance with the “best effort” principle, while accepting relatively rare occurrences of packet losses and time delays. Two approaches are being discussed for CAC algorithms, i.e. a stochastic and a deterministic approach. Stochastic in conjunction with this algorithm means that by multiplexing, an averaging of the burst resulting in a higher average usage of the communication network with a higher overload risk is hoped for. Deterministic in conjunction with this algorithm means that the bandwidth of the communication network is conservatively allocated using assured traffic characteristics such as the so called peak bit rate (PBR). As can be seen from the following, the inventors propose a combination of both approaches and therefore comes to an adaptive CAC algorithm. The basis of this is stochastic offline traffic models, with the strategy being adapted in real time if a special critical dynamic or characteristic occurs. Networks of pulsed neurons are used for this model.

A neural network has neurons that are at least partially linked to each other. Input signals are applied as input variables to input neurons of the neural network. The neural network normally has several layers. Depending on input variables applied to a neuron of the neural network and an activation function provided for the neuron, a neuron in each case generates a signal that in turn is applied to neurons of a further layer as an input variable in accordance with a predetermined weighting. In an output layer, an output variable is generated in an output neuron depending on variables that are applied to the output neuron from neurons of the preceding layer.

The neural network codes information by action potentials or pulses (spikes) that characterize the neural firing events. As part of the time coding, spatio-temporal firing patterns therefore code information with respect to sensory stimuli. In other words, different classes of stimuli can be distinguished by different types of spatio-temporal firing patterns. In this connection, the maximization of the transinformation as a way to describe the distinguishability for achievement of this objective was recently proposed. By maximizing the transinformation between the name of the entered class and the resulting pulse pattern, provided by the neurons that carry out the coding of the presented stimulus, optimum distinguishing properties are ensured.

### SUMMARY OF THE INVENTION

One potential objective of this invention is to create a method for classifying the traffic dynamism of a network communication that guarantees a reliable classification of the traffic dynamism by a relatively clear computing effort.

A further potential object is to provide a neural network for classification of the traffic dynamism of a network communication that guarantees a reliable classification of the traffic dynamism with a relatively clear computing effort.

A further object is to create a system for carrying out the method for classification of the traffic dynamism of a network communication that enables a reliable classification of the traffic dynamism in a processor with a relatively small capacity.

Relevant questions for networks of pulsed neurons in conjunction with the classification of the traffic dynamism of a network communication are, as already mentioned, the classification of traffic streams in communication networks, particularly computer networks, and the detection of traffic characteristics, which can also take place online, that deviate from basic assumptions or negotiated values and therefore jeopardize the guarantee of the QoS. Here is an example of this. If a data stream with a property x requests a transmission, the CAC knows that, based on model assumptions, acceptance of x is theoretically possible without overloading the given network resources. However, by measurement of the streams already taken up, a deviation from model assumptions is detected. This is an unexpected critical characteristic of the data flow already running. The consequence is an adaptation extending up to a conservative strategy with the rejection of x. This procedure is thus based on the knowledge that instead of focusing on bit rates (rate coding) when monitoring the maintenance of negotiated traffic characteristics when determining and estimating the resource usage, focusing on critical burst patterns (temporal coding) can achieve the objective. The background is that, first of all, special simultaneously occurring load peaks occur and not average bit rates, that of themselves can also be controlled with fewer problems.

As a further application, the method provides for the creation of a “who-communicates-with whom” matrix in online operation, expanded if necessary by the “type of communication” dimension. The object is accordingly the classification of the outgoing data streams of several, for example two, computers and therefore the number of data packets transmitted in each time interval, plotted as a function of time, in a “common communication” class and an “independent of each other communication” class. The result of this classification is that one entry in this matrix exists for each pair of computers in the network, with 1 signifying a common communication and 0 communication between the computers independent of each other. This matrix thus presents a chessboard pattern with the possibility of detecting deviations from the norm. Lines/columns consisting exclusively of zeros, for example, indicate a failure of communication (fault), whereas lines/columns containing exclusively ones can indicate an external attack (fraud). However, more complex matrix patterns can also provide information on the state of the system, e.g. by classification in attributes such as “normal/abnormal” , “overloaded”, “danger of overload”, etc.

In other words, the core of the method is the inclusion of temporal coding in adaptive neural network techniques by a formulation of pulses that mathematically is relatively simple. This presents a novel possibility of signal processing. Particularly for tasks that approach typical human strengths, such as the recognition of spatio-temporal patterns, that for example are necessary for speech recognition and computer network traffic problems, advantages can be expected by a technique which very closely simulates the working of the human brain.

The classification of temporal patterns (temporal clustering) referred to takes place by a synaptic model, the dynamism of which depends directly on the exact clocking or time control of pre- or post-synaptic pulses. For this purpose, the model roughly implements the main short-term functionalities of a biological synapse, i.e. the facilitation and depression of the transmission. Furthermore, the short-term dynamic of the model is adaptable. This means that the synapse changes the relationship between the facilitation and depression, with the time pattern of its maximum response behavior, and thus its delay effect, being changed to a train of pulses.

The synaptic properties referred to result from the condition due to the pulse-time-dependent synaptic resources controlled by the interaction of the following equations.

For a synaptic transmission of incoming pulses, the concentration of C given by Ca²⁺ in the pre-synaptic button or terminal button is first determined, the button being modeled in real time between 0 and 1. A low diffusion process in the excess cellular space and a rapid opening of calcium-dependent ion channels on the arrival of a pre-synaptic pulse can be reckoned with at time t^{sp}ₚᵣₑ as follows:

$$\frac{ⅆ}{ⅆ t} C = - \frac{C}{{τ}_{fac}} + δ ( t - {t}_{pre}^{sp} ) \cdot {C}_{0} \cdot ( 1 - C ) \qquad ( 1 )$$

with C responding to an exponential reduction with a time constant τ_{fac} and being reset in the case of pre-synaptic pulse arrival times that are reflected by the δ distribution. With this jump in the Ca²⁺-concentration, C is scaled by the adaptable parameter C₀ that determines the time pattern of the maximum EPSP (an alpha-shaped excitation potential) that can be generated by the synapse. C₀ represents the amount of calcium that enters into the cell or, in other words, it only reflects how calcium ion channels can open without problems. For C₀ there is exactly the same learning parameter, the corresponding equation for which is given in the following.

In pre-synaptic release points for neurotransmitters, synaptic vesicles are either docked or not docked. The proportion of release points that actually have a docked vesicle is given by the variable Pᵥ. Pᵣₑₗ is that proportion of the docked vesicles that is released in the case of a pre-synaptic firing. Here it is assumed that each docked vesicle requires four calcium ions for release. For this reason, C is included in the equation with exponent 4. The proportion of releasable vesicles increases in line with C. In this case, it is a facilitating part of the synapse:
Pᵣₑₗ=Pᵥ·C⁴ (2)
whereby Pᵥ is itself controlled by the following equation:

$$\frac{ⅆ}{ⅆ t} {P}_{υ} = \frac{1 - {P}_{υ}}{{τ}_{rec}} - δ ( t - {t}_{pre}^{sp} ) \cdot {P}_{rel} \cdot {P}_{υ} \qquad ( 3 )$$

Pᵥ is the fraction of the currently available vesicle resources available for a neurotransmitter release. Pᵥ in the completely recovered state has a value of 1, with the recovery being regulated by the recovery time constant τ_{rec} that results in an exponential recovery process in the absence of pre-synaptic pulses. This recovery process represents the following output or delivery of vesicles from the cell cores. When τ_{rec} is rather large, incoming pulses lead to a depletion of vesicle resources. This is the depression part of the synapse.

An EPSP is thus introduced at the post-synaptic side that depends on Pᵣₑₗ at the time point of a pre-synaptic pulse:

$$\frac{ⅆ}{ⅆ t} EPSP = - \frac{EPSP}{{τ}_{EPSP}} + δ ( t - {t}_{pre}^{sp} ) \cdot {P}_{rel} \qquad ( 4 )$$

Equations (1) to (4) control the principle dynamism of the synapse in response to pre-synaptic pulses. The resulting short-term effects include facilitation and depression. The relationship between these two effects, that can be changed by varying C₀, controls the time point of the maximum response in the EPSP and thus the delay effect during transmission.

FIG. 1 shows different synaptic response types for different values of the synaptic parameter C₀. The synaptic delay, i.e. its maximum response behavior, varies from a sudden response behavior to a slower response behavior. The post-synaptic integration and firing neuron, subject to potential loss due to diffusion, receives from one synapse a train of equally spaced pulses. FIG. 1 shows the membrane potential of this synaptic neuron.

The learning process, an effect extending over a relatively long period, that leads to the adaptation of an introduced short-term dynamism, is carried out as detailed in the following.

The mechanism of learning synaptic delay processes, independent of pre-synaptic and post-synaptic pulse patterns, is now explained. The core of the learning algorithm is as follows. If a post-synaptic pulse occurs before a synapse has reached its maximum response behavior, the algorithm performs an adaptation so that it reaches its maximum earlier next time. This means that C₀ increases or enlarges. In a case where the post-synaptic pulse occurs after a synapse has already reached its maximum response behavior, the synapse will similarly attempt next time to additionally delay its response behavior, which means that C_{O} is lessened or reduced. How this is achieved in detail is now explained.

A neurotransmitter concentration N is first introduced into the synaptic gap:

$$\frac{ⅆ}{ⅆ t} N = - \frac{N}{{τ}_{N}} + δ ( t - {t}_{pre}^{sp} ) \cdot {P}_{rel} \cdot ( 1 - N ) \cdot {α}_{N} \qquad ( 5 )$$

with τ_{N} being the time constant of a neurotransmitter decay, and α_{N} being a release coefficient. In this case, the size of τ_{N} is chosen to be the same as the membrane constant of the output neuron, so that N reflects the contribution of this synapse to the post-synaptic membrane potential. The maximum of N should occur together with the maximum effect of this synapse on a post-synaptic neuron. To determine this maximum it is necessary to determine the first derivation of the envelope curve of the time pattern of N. An additional variable \overline{N} is required for this purpose.

$$\frac{ⅆ}{ⅆ t} \overline{N} = - \frac{N - \overline{N}}{{τ}_{\overline{N}}} + δ ( t - {t}_{pre}^{sp} - Δ t ) \cdot ( N - \overline{N} ) \qquad ( 6 )$$

It is assumed of \overline{N} that it stores the value of N starting from the last firing event. The purpose of \overline{N} is to determine whether the synapse currently releases more or fewer transmitters compared with the preceding firing event. Whether N has a tendency to increase or decrease can be determined by subtracting N from \overline{N}. The updating, i.e. the setting of \overline{N} to N for pre-synaptic firing takes place some time after the pre-synaptic pulse has occurred, as shown by Δt in the δterm. It is assumed that \overline{N} is the neurotransmitter concentration at a point a little distant from the release point, so that the concentration requires a certain time Δt to move to that point. In the simulation, a time step, i.e. of 1 ms, is chosen for Δt. It is important that τ_{\overline{N}} is large enough for \overline{N} to be actually able to store the value of N starting from the last firing event.

N-\overline{N} is henceforth used at each time step to determine the value C*₀ with which C₀ must be changed when a post-synaptic pulse occurs.

$$\frac{ⅆ}{ⅆ t} {C}_{0}^{*} = \{ \begin{matrix}- \frac{{C}_{0}^{*}}{{τ}_{{C}_{0}^{*}}} + δ ( t - {t}_{pre}^{sp} ) \cdot ( - {C}_{0}^{*} + ( ( N - \overline{N} ) \cdot {α}_{{C}_{0}^{*}} \cdot {p}_{rel} \cdot ( 1 - {C}_{0} ) ) ) \\ wenn ( N - \overline{N} ) \geq 0 \\ - \frac{{C}_{0}^{*}}{{τ}_{{C}_{0}^{*}}} + δ ( t - {t}_{pre}^{sp} ) \cdot ( - {C}_{0}^{*} + ( ( N - \overline{N} ) \cdot {α}_{{C}_{0}^{*}} \cdot {p}_{rel} \cdot {C}_{0} ) ) \\ wenn ( N - \overline{N} ) < 0\end{matrix} \qquad ( 7 )$$

In this case, α_{C*0} is the learning rate. The division into two cases when determining C*₀ in equation 7 is done to ensure that C₀ is restricted between 0 and 1.

When the post-synaptic pulse actually occurs, C₀ is then changed by C*₀.

$$\frac{ⅆ}{ⅆ t} {C}_{0} = δ ( t - {t}_{post}^{sp} ) \cdot {C}_{0}^{*} \qquad ( 8 )$$

FIG. 2 shows the corresponding curves of N together with C*₀. After the learning period, the zero crossings of the last named curves coincide with the maximum response of the maxima of N.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a various forms of synaptic response behavior in response to the adaptable synaptic parameter C₀* with smaller values of C₀, the peak value response moves to the right and thus leads to a delay in the transmission;

FIG. 2A is different time patterns of neurotransmitter concentrations N for different values of the parameter C₀;

FIG. 2B is updating curves C*₀; these curves determine the direction and magnitude of the change when C₀ is updated; it will be noted that the zero crossings coincide with the corresponding maxima in a neurotransmitter concentration, which means that C₀ is not changed if a post-synaptic pulse is generated at the precise time point of the maximum synaptic response; if a post-synaptic pulse occurs before the maximum is reached, C₀ drops; if a post-synaptic pulse occurs after the maximum is reached, C₀ rises or becomes greater.

FIG. 3 is an example of temporal clustering with pulsed neurons in a computer network administration.

FIG. 4 is a typical application spectrum of the temporal clusters according to FIG. 3.

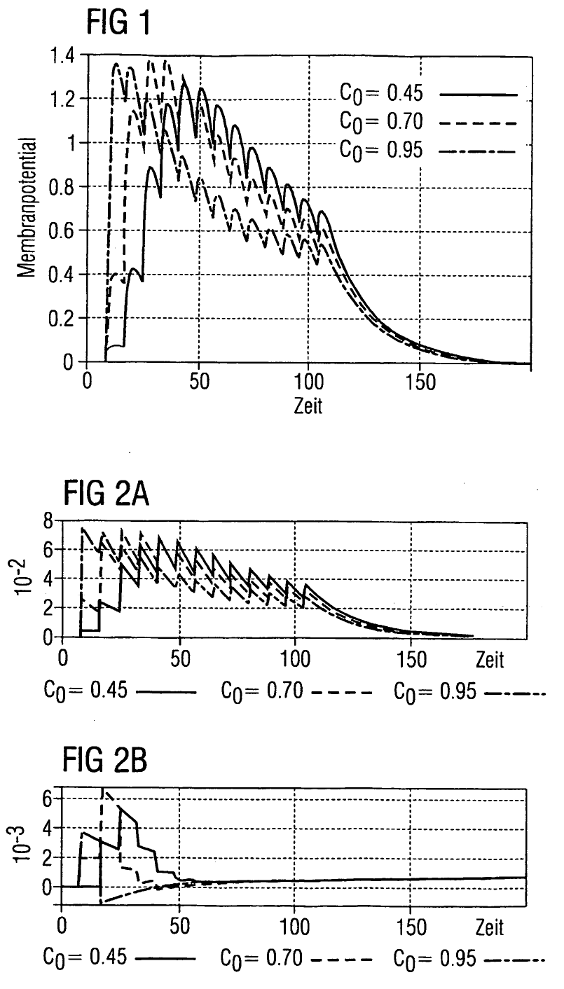

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

A particularly advantageous analysis technique has been explained above for temporal-dynamic structures in respect of the detection of patterns, of the characterization of the dynamism and classification of time series, based on the use of a network of pulsed neurons. This is a recurring, i.e. dynamic, network whose network elements, the neurons, are modulated by dynamic threshold value elements in a very similar manner to natural nervous systems. These process their weighted inputs in the form of changes in the natural charge state and generate their output if the threshold is exceeded by transmitting action potentials, also known as discharge.

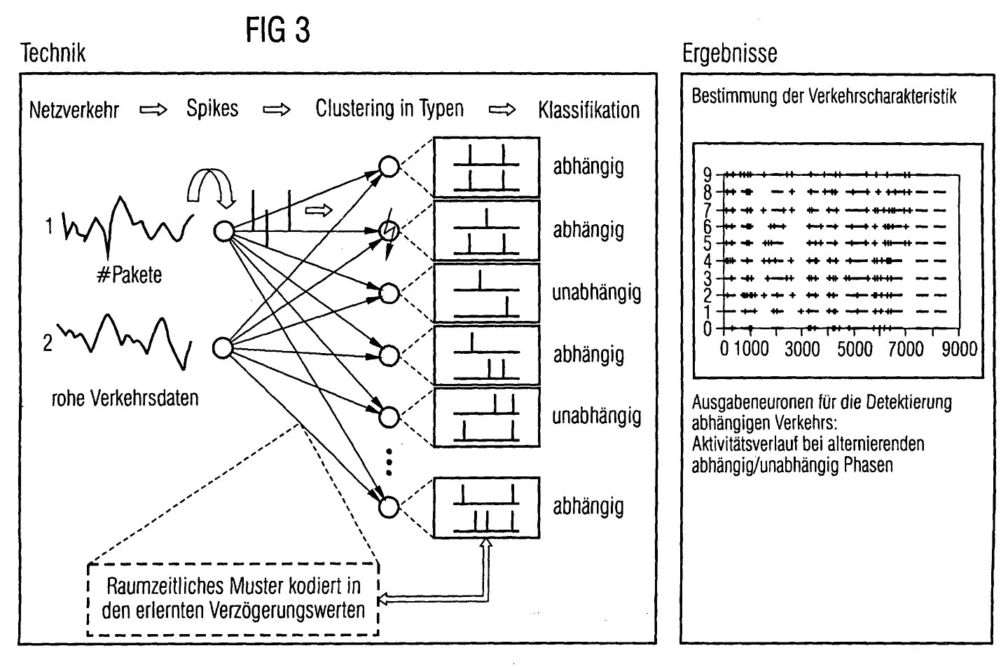

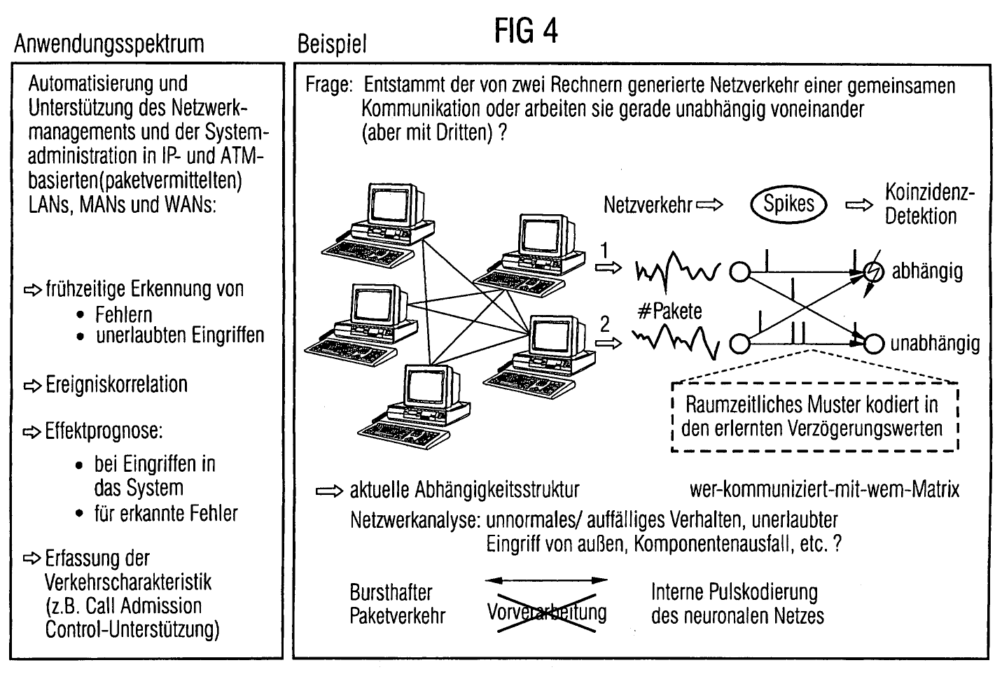

Feedback and time delays in the network connections enable the network to dynamically store relevant information on earlier inputs and process steps in a natural way without limitation due to the architecture, and thus to directly examine the temporal dynamism of the incoming stream as required and learn its characteristics. Examples of this in the configuration of the traffic dynamism of a computer network communication using pulsed neurons are shown in the self-explanatory schematics of FIG. 3 and FIG. 4.

The temporal spacing between successive action potentials or resulting spatio-temporal activity patterns of the network and the distinctive component of the internal coding of the system (temporal coding or temporal clustering) thus becomes analogous to the example of the human brain. Furthermore, coding in the form of point processes or discrete processes instead of continuous stochastic processes as a central property of this kind of information processing offers substantial advantages in the use of mathematical learning functions.

On the basis of the aforementioned properties, a network of this kind is very good for classifying temporal patterns (temporal clustering), such as occur during the analysis of traffic characteristics in computer networks, as shown in FIG. 4.

The invention has been described in detail with particular reference to preferred embodiments thereof and examples, but it will be understood that variations and modifications can be effected within the spirit and scope of the invention.

1-12. (canceled)

13. A method for classifying traffic dynamism of a communication network using a neural network that contains pulsed neurons, comprising:
using traffic data of the communication network as input variables for the neural network;
obtaining temporal clusters by pulse processing;
using the temporal clusters as output variables of the neural network; and
classifying the traffic dynamism using a synaptic model, the dynamism of the synaptic model depending directly on precise clocking of pre- and post-synaptic pulses.

14. A method according to claim 13, wherein the dynamism of the synaptic model is determined by the following equations:
$$\frac{ⅆ}{ⅆ t} C = - \frac{C}{{τ}_{fac}} + δ ( t - {t}_{pre}^{sp} ) \cdot {C}_{0} \cdot ( 1 - C ) \qquad ( 1 )$$
wherein
C represents an amount of Ca²⁺ in a neural cell with C responding to an exponential reduction with a time constant τ_{fac} and being reset for pre-synaptic pulse arrival times that are reflected by δ (t-tₚᵣₑ^{sp}), which creates a jump in Ca²⁺-concentration,
tₚᵣₑ^{sp} is a time of the pre-synaptic pulse,
C₀ is an adaptable parameter to scale C, C₀ determines a time pattern of a maximum alpha type excitation potential (EPSP) that can be generated by a synapse, C₀ representing the amount of calcium that enters into the cell,
C₀ has a learning parameter given in the following;
Pᵣₑₗ=Pᵥ·C⁴ (2)
with Pᵣₑₗ being a proportion of docked vesicles that is released at a pre-synaptic firing and with Pᵥ being controlled by the following equation:
$$\frac{ⅆ}{ⅆ t} {P}_{v} = \frac{1 - {P}_{v}}{{τ}_{rec}} - δ ( t - {t}_{pre}^{sp} ) \cdot {P}_{rel} \cdot {P}_{v} \qquad ( 3 )$$
with Pᵥ being the fraction vesicle resources ready for a neurotransmitter release;
$$\frac{ⅆ}{ⅆ t} EPSP = - \frac{EPSP}{{τ}_{EPSP}} + δ ( t - {t}_{pre}^{sp} ) \cdot {P}_{rel} \qquad ( 4 )$$
with EPSP being the alpha-type excitation potential introduced at a post-synaptic end, the time of the pre-synaptic pulse depending on Pᵣₑₗ.

15. A method according to claim 14, wherein,
a short-term traffic dynamism is adapted with a learning process for synaptic delay processes,
the learning process depends on pre-synaptic and post-synaptic pulse patterns and is specified by the following formulae:
$$\frac{ⅆ}{ⅆ t} N = - \frac{N}{{τ}_{N}} + δ ( t - {t}_{pre}^{sp} ) \cdot {P}_{rel} \cdot ( 1 - N ) \cdot {α}_{N} \qquad ( 5 )$$
wherein τ_{N} is a time constant of a neurotransmitter decay,
Δ_{N} is a release coefficient,
τ_{N} is equal to a membrane constant of an output neuron,
N reflects a contribution of the synapse to a post-synaptic membrane potential,
a maximum N is determined from a first derivation of an envelope of a time pattern of N:
$$\frac{ⅆ}{ⅆ t} \overline{N} = - \frac{N - \overline{N}}{{τ}_{\overline{N}}} + δ ( t - {t}_{pre}^{sp} - Δ t ) \cdot ( N - \overline{N} ) \qquad ( 6 )$$
\overline{N} is an additional variable that stores a value of N starting from a last firing event,
N-\overline{N} is used at each time step to determine C*₀,
C*₀ is used to change C₀ as follows:
$$\frac{ⅆ}{ⅆ t} {C}_{0}^{*} = \{ \begin{matrix}\begin{matrix}- \frac{{C}_{0}^{*}}{{τ}_{{C}_{0}^{*}}} + δ ( t - {t}_{pre}^{sp} ) \cdot ( - {C}_{0}^{*} + ( ( N - \overline{N} ) . {α}_{{C}_{0}^{*}} \cdot \\ {P}_{rel} \cdot ( 1 - {C}_{0} ) \overline{)} ) when ( N - \overline{N} ) \geq 0\end{matrix} \\ \begin{matrix}- \frac{{C}_{0}^{*}}{{τ}_{{C}_{0}^{*}}} + δ ( t - {t}_{pre}^{sp} ) \cdot ( - {C}_{0}^{*} + ( ( N - \overline{N} ) . {α}_{{C}_{0}^{*}} \cdot \\ {P}_{rel} \cdot {C}_{0} ) ) \overline{)} when ( N - \overline{N} ) < 0\end{matrix}\end{matrix} \qquad ( 7 )$$
α_{C*0} is a learning rate, and
when the post-synaptic pulse occurs, C₀ is changed by C*₀ as follows:
$$\frac{ⅆ}{ⅆ t} {C}_{0} = δ ( t - {t}_{post}^{sp} ) \cdot {C}_{0}^{*} \qquad ( 8 )$$

16. A method according to claim 13, wherein the traffic dynamism is the dynamism between at least two computers connected via a LAN, MAN or WAN.

17. A neural network comprising:
pulsed neurons to classify the traffic dynamism of a communication network:
a synaptic model having a dynamism which depends directly on precise clocking of pre-synaptic and post-synaptic pulses, with traffic data of the communication network forming input variables for the neural network; and
temporal clusters obtained by pulse processing, the temporal clusters forming output variables of the neural network.

18. A neural network according to claim 17, wherein the dynamism of the synaptic model is determined by the following equations:
$$\frac{ⅆ}{ⅆ t} C = - \frac{C}{{τ}_{fac}} + δ ( t - {t}_{pre}^{sp} ) \cdot {C}_{0} \cdot ( 1 - C ) \qquad ( 1 )$$
wherein
C represents an amount of Ca²⁺ in a neural cell with C responding to an exponential reduction with a time constant τ_{fac} and being reset for pre-synaptic pulse arrival times that are reflected by δ (t-tₚᵣₑ^{sp}), which creates a jump in Ca²⁺-concentration,
tₚᵣₑ^{sp} is a time of the pre-synaptic pulse,
C₀ is an adaptable parameter to scale C, C₀ determines a time pattern of a maximum alpha type excitation potential (EPSP) that can be generated by a synapse, C₀ representing the amount of calcium that enters into the cell,
C₀ has a learning parameter given in the following;
Pᵣₑₗ=Pᵥ·C⁴ (2)
with Pᵣₑₗ being a proportion of docked vesicles that is released at a pre-synaptic firing and with Pᵥ being controlled by the following equation:
$$\frac{ⅆ}{ⅆ t} {P}_{v} = \frac{1 - {P}_{v}}{{τ}_{rec}} - δ ( t - {t}_{pre}^{sp} ) \cdot {P}_{rel} \cdot {P}_{v} \qquad ( 3 )$$
with Pᵥ being the fraction vesicle resources ready for a neurotransmitter release;
$$\frac{ⅆ}{ⅆ t} EPSP = - \frac{EPSP}{{τ}_{EPSP}} + δ ( t - {t}_{pre}^{sp} ) \cdot {P}_{rel} \qquad ( 4 )$$
with EPSP being the alpha-type excitation potential introduced at a post-synaptic end, the time of the pre-synaptic pulse depending on Pᵣₑₗ.

19. A neural network according to claim 18, wherein
a short-term traffic dynamism is adapted with a learning process for synaptic delay processes,
the learning process depends on pre-synaptic and post-synaptic pulse patterns and is specified by the following formulae:
$$\frac{ⅆ}{ⅆ t} N = - \frac{N}{{τ}_{N}} + δ ( t - {t}_{pre}^{sp} ) \cdot {P}_{rel} \cdot ( 1 - N ) \cdot {α}_{N} \qquad ( 5 )$$
wherein τ_{N} is a time constant of a neurotransmitter decay,
α_{N} is a release coefficient,
τ_{N} is equal to a membrane constant of an output neuron,
N reflects a contribution of the synapse to a post-synaptic membrane potential,
a maximum N is determined from a first derivation of an envelope of a time pattern of N:
$$\frac{ⅆ}{ⅆ t} \overline{N} = - \frac{N - \overline{N}}{{τ}_{\overline{N}}} + δ ( t - {t}_{pre}^{sp} - Δ t ) \cdot ( N - \overline{N} ) \qquad ( 6 )$$
\overline{N} is an additional variable that stores a value of N starting from a last firing event,
N-\overline{N} is used at each time step to determine C*₀,
C*₀ is used to change C₀ as follows:
$$\frac{ⅆ}{ⅆ t} {C}_{0}^{*} = \{ \begin{matrix}\begin{matrix}- \frac{{C}_{0}^{*}}{{τ}_{{C}_{0}^{*}}} + δ ( t - {t}_{pre}^{sp} ) \cdot ( - {C}_{0}^{*} + ( ( N - \overline{N} ) . {α}_{{C}_{0}^{*}} \cdot \\ {P}_{rel} \cdot ( 1 - {C}_{0} ) \overline{)} ) when ( N - \overline{N} ) \geq 0\end{matrix} \\ \begin{matrix}- \frac{{C}_{0}^{*}}{{τ}_{{C}_{0}^{*}}} + δ ( t - {t}_{pre}^{sp} ) \cdot ( - {C}_{0}^{*} + ( ( N - \overline{N} ) . {α}_{{C}_{0}^{*}} \cdot \\ {P}_{rel} \cdot {C}_{0} ) ) \overline{)} when ( N - \overline{N} ) < 0\end{matrix}\end{matrix} \qquad ( 7 )$$
αc*0 is a learning rate, and
when the post-synaptic pulse occurs, C₀ is changed by C*₀ as follows:
$$\frac{ⅆ}{ⅆ t} {C}_{0} = δ ( t - {t}_{post}^{sp} ) \cdot {C}_{0}^{*} \qquad ( 8 )$$

20. A neural network according to claim 17, wherein the traffic dynamism is the dynamism between at least two computers connected via a LAN, MAN or WAN.

21. A computer readable medium to control a processor to perform a method for classification of the traffic dynamism of a communication network, the method comprising:
using traffic data of the communication network as input variables for the neural network;
obtaining temporal clusters by pulse processing;
using the temporal clusters as output variables of the neural network; and
classifying the traffic dynamism using a synaptic model, the dynamism of the synaptic model depending directly on precise clocking of pre- and post-synaptic pulses.

22. A computer readable medium wherein the dynamism of the synaptic model is determined by the following equations:
$$\frac{ⅆ}{ⅆ t} C = - \frac{C}{{τ}_{fac}} + δ ( t - {t}_{pre}^{sp} ) \cdot {C}_{0} \cdot ( 1 - C ) \qquad ( 1 )$$
wherein
C represents an amount of Ca²⁺ in a neural cell with C responding to an exponential reduction with a time constant τ_{fac} and being reset for pre-synaptic pulse arrival times that are reflected by δ (t-tₚᵣₑ^{sp}) , which creates a jump in Ca²⁺-concentration,
tₚᵣₑ^{sp} is a time of the pre-synaptic pulse,
C₀ is an adaptable parameter to scale C, C₀ determines a time pattern of a maximum alpha type excitation potential (EPSP) that can be generated by a synapse, C₀ representing the amount of calcium that enters into the cell,
C₀ has a learning parameter given in the following;
Pᵣₑₗ=Pᵥ·C⁴ (2)
with Pᵣₑₗ being a proportion of docked vesicles that is released at a pre-synaptic firing and with Pᵥ being controlled by the following equation:
$$\frac{ⅆ}{ⅆ t} {P}_{v} = \frac{1 - {P}_{v}}{{τ}_{rec}} - δ ( t - {t}_{pre}^{sp} ) \cdot {P}_{rel} \cdot {P}_{v} \qquad ( 3 )$$
with Pᵥ being the fraction vesicle resources ready for a neurotransmitter release;
$$\frac{ⅆ}{ⅆ t} EPSP = - \frac{EPSP}{{τ}_{EPSP}} + δ ( t - {t}_{pre}^{sp} ) \cdot {P}_{rel} \qquad ( 4 )$$
with EPSP being the alpha-type excitation potential introduced at a post-synaptic end, the time of the pre-synaptic pulse depending on Pᵣₑₗ.

23. A computer readable medium according to claim 22, wherein
a short-term traffic dynamism is adapted with a learning process for synaptic delay processes,
the learning process depends on pre-synaptic and post-synaptic pulse patterns and is specified by the following formulae:
$$\frac{ⅆ}{ⅆ t} N = - \frac{N}{{τ}_{N}} + δ ( t - {t}_{pre}^{sp} ) \cdot {P}_{rel} \cdot ( 1 - N ) \cdot {α}_{N} \qquad ( 5 )$$
wherein τ_{N} is a time constant of a neurotransmitter decay,
α_{N} is a release coefficient,
τ_{N} is equal to a membrane constant of an output neuron,
N reflects a contribution of the synapse to a post-synaptic membrane potential,
a maximum N is determined from a first derivation of an envelope of a time pattern of N:
$$\frac{ⅆ}{ⅆ t} \overline{N} = - \frac{N - \overline{N}}{{τ}_{\overline{N}}} + δ ( t - {t}_{pre}^{sp} - Δ t ) \cdot ( N - \overline{N} ) \qquad ( 6 )$$
\overline{N} is an additional variable that stores a value of N starting from a last firing event,
N-\overline{N} is used at each time step to determine C*₀,
C*₀ is used to change C₀ as follows:
$$\frac{ⅆ}{ⅆ t} {C}_{0}^{*} = \{ \begin{matrix}\begin{matrix}- \frac{{C}_{0}^{*}}{{τ}_{{C}_{0}^{*}}} + δ ( t - {t}_{pre}^{sp} ) \cdot ( - {C}_{0}^{*} + ( ( N - \overline{N} ) . {α}_{{C}_{0}^{*}} \cdot \\ {P}_{rel} \cdot ( 1 - {C}_{0} ) \overline{)} ) when ( N - \overline{N} ) \geq 0\end{matrix} \\ \begin{matrix}- \frac{{C}_{0}^{*}}{{τ}_{{C}_{0}^{*}}} + δ ( t - {t}_{pre}^{sp} ) \cdot ( - {C}_{0}^{*} + ( ( N - \overline{N} ) . {α}_{{C}_{0}^{*}} \cdot \\ {P}_{rel} \cdot {C}_{0} ) ) \overline{)} when ( N - \overline{N} ) < 0\end{matrix}\end{matrix} \qquad ( 7 )$$
α_{C*0} is a learning rate, and
when the post-synaptic pulse occurs, C₀ is changed by C*₀ as follows:
$$\frac{ⅆ}{ⅆ t} {C}_{0} = δ ( t - {t}_{post}^{sp} ) \cdot {C}_{0}^{*} \qquad ( 8 )$$

24. A computer readable medium according to claim 21, wherein the traffic dynamism is the dynamism between at least two computers connected via a LAN, MAN or WAN.
